(19) United States
(12) Patent Application Publication
(10) Pub. No.: US 2003/0074455 A1
(43) Pub. Date: Apr. 17, 2003

(54) Context aware server devices

(75) Inventors: Kenneth Ray Banning, Austin, TX (US); Tai Anh Cao, Austin, TX (US); Khanh Nguyen, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY (US)

(21) Appl. No.: 09/974,982

(22) Filed: Oct. 11, 2001

(51) Int. Cl. G06F 15/16

(52) U.S. Cl. 709/229; 709/203

(57) ABSTRACT

A server system and method in which the server determines whether a requesting client is accessing a requested document or page in a manner contemplated by the server. The server may first determine whether the client has direct access authority such as by interpreting cookie information supplied with the client request. The client may obtain direct access authority if the client has previously accessed server documents in a prescribed manner. If the client lacks direct access, the server may determine if the client has been referred or quoted to the requested page by a third party server or referrer that has authority to refer clients to the requested page. The server device may maintain a table of information in its storage to facilitate the determination of which referring parties have authority to which documents on the server. If the server determines that a particular request lacks both direct access authority and indirect authority, the server may return a version of the requested document (the unauthorized version) that indicates the lack of authority. The server may generate the unauthorized version of a document from the authorized version by executing a script to insert text or otherwise change the appearance of the returned document.

### BACKGROUND

1. Field of the Present Invention

The present invention generally relates to the field of data processing networks and more particularly to the use of information embedded in network data packets to control the content of information returned to a requesting client.

2. History of Related Art

Data processing networks are widely implemented to provide distributed information and services to a large numbers of network clients who may be geographically dispersed over a wide area. The Internet, as the most universally recognizable data processing network, enables substantially any client to request information from thousands of servers without regard to the particular hardware or platform employed by the client, the targeted server, or any intervening network device.

Freely accessible server documents, while beneficially enabling the wide-spread dissemination of data and service, can raise control issues to the owners or authors of information that is placed on the servers. If, for example, an author maintains a set of pages on a server, the author may wish to maintain the pages in context such as in a particular order to prevent the client from accessing subordinate pages out-of-order.

To maintain this type of control, the author may restrict access to a subordinate page on the server. This control may be relatively easy to implement in the cases where the client accesses the author's page(s) directly such as when a client enters the server's Universal Resource Indicator (URI) using an Internet browser or other similar application. When an author's pages are accessed directly, the server can maintain control over access to subordinate documents by the placement of links to the subordinate pages.

Web pages and other network information may, however, also be accessed indirectly. In an indirect access, a client is referred to the web pages of a third party by the server to which the client is directly connected. In a familiar example of an indirect access, a web page may include a link that connects the user to a third party when clicked.

It would be desirable to implement a system and method for verifying that a client request for a “contextual” document is made within the desired context. It would be further desirable if the implemented system and method did not substantially add to the complexity of the server design and did not significantly increase server storage requirements or negatively impact server responsiveness.

### SUMMARY OF THE INVENTION

The problems identified above are in large part addressed by a system and method in which a server determines whether a requesting client is accessing a requested document or page in a manner contemplated by the server. The server may first determine whether the client has direct access authority such as by interpreting cookie information supplied with the client request. The client may obtain direct access authority if the client has previously accessed server documents in a prescribed manner. If the client lacks direct access, the server may determine if the client has been referred or quoted to the requested page by a third party server or referrer that has authority to refer clients to the requested page. The server device may maintain a table of information in its storage to facilitate the determination of which referring parties have authority to which documents on the server. If the server determines that a particular request lacks both direct access authority and indirect authority, the server may return a version of the requested document (the unauthorized version) that indicates the lack of authority. The server may generate the unauthorized version of a document from the authorized version by executing a script to insert text or otherwise change the appearance of the returned document.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing network including a server according to one embodiment of the invention;

FIG. 2 is a flow diagram illustrating a method of handling client requests according to one embodiment of the present invention;

FIG. 3 is a conceptual illustration of a table of authorization information according to one embodiment of the invention maintained by the server device of FIG. 1; and

FIG. 4 is a conceptual illustration of a server device handling client requests for documents according to the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

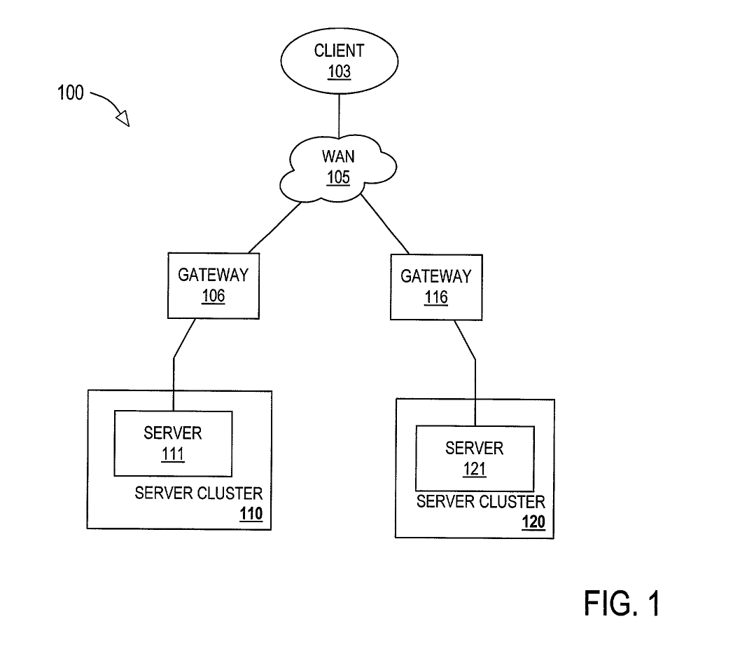

Before describing details of the invention, a general description of a data processing network suitable for employing the invention is presented to provide context for the subsequent discussion. Referring to FIG. 1, a block diagram of selected features of a data processing network 100 suitable for use in one embodiment of the present invention is shown. In the depicted embodiment, data processing network 100 includes a first server cluster 110 that is connected to a wide area network (WAN) 105 through an intermediate gateway 106 and a second server cluster 120 connected to WAN 105 through a second gateway 116. WAN 105 may include a multitude of various network devices including gateways, routers, hubs, and so forth as well as one or more local area networks (LANs) all interconnected over a potentially wide-spread geographic area. WAN 105 may represent the Internet in one embodiment.

Server cluster 110 may include one or more server devices (servers) 111 as well as additional network devices such as a network switch and networked storage devices all connected in a shared media or point-to-point local area network (LAN) configuration. In its simplest embodiment, server cluster 110 comprises a single server 111 connected to WAN 105. Server cluster 110 may represent a particular universal resource indicator (URI) on data processing network 100 such that all network requests specifying the URI are routed to and processed by server cluster 110. Server 111 includes a system memory and at least one processor capable of accessing data and instructions stored in the system memory as is typical in the field.

Network 100 further includes a second server cluster 120 connected to WAN 105. Second server cluster 120, like first server cluster 110, includes at a minimum a server device 121 and may include additional servers and network devices. Second server cluster 120 typically represents a second URI on network 100. Network requests that reference the second URI are directed to and processed by second server cluster 120.

To accommodate the potentially disparate platforms of various network devices, data processing networks typically employ a network protocol that provides a common set of rules and specifications with which network aware applications must comply to communicate via the network.

Network protocols are typically described as comprising a set of protocol layers starting with a lowest layer concerned with the network's physical media to a highest layer that specifies end-user and end-application protocols. The Open Systems Interconnect (OSI) Reference Model, for example, identifies seven layers of a typical network protocol stack.

Each layer defines the protocols and functions related to a specific portion of the network communication process. These layers include a network layer protocol such as the Internet Protocol (IP) that defines the manner in which network connections are established and maintained and a transport layer protocol such as the Transmission Control Protocol (TCP) that ensures the integrity and reliability of messages exchanged via a network connection. The TCP/IP suite of protocols provides the backbone for a large number of data processing networks including the Internet. The IP and TCP specifications are publicly available as RFC's 791 and 793 respectively from the Internet Engineering Task Force (IETF) at www.ietf.org.

A variety of application layer protocols can execute on top of a TCP/IP compliant network. Among the more commonly encountered of such protocols is the Hypertext Transfer Protocol (HTTP) as defined in IETF RFC 2616. In a typical HTTP sequence, a client application such as a conventional web browser initiates a GET request that specifies the URI of the resource from which information is desired (the request-URI). The request is routed to the request-URI, which then responds by returning a file, executing an application such as a cgi script, or a combination of both.

HTTP employs one or more headers to convey information that can be used to modify the manner in which an HTTP request is processed. Among the headers specified by HTTP is the request header, that includes a field, referred to as the referer (sic) field. The referer field allows the client to specify the URI of the resource from which the request-URI was obtained (the “referrer”). The referer field enables a server to generate lists of back-links to resources for interest, logging, and optimized caching. It also allows obsolete or mistyped links to be traced for maintenance.

HTTP is a “stateless” protocol in which requests and responses are independent of previous requests and responses. To facilitate a wide variety of client-server sessions, many servers generate state information that can be used to differentiate and customize interactions with various clients. State information may be used in HTTP, for example, to identify a particular client session to facilitate shopping cart transactions. HTTP state information mechanisms are detailed in D. Kristol et al., HTTP State Management Mechanism, RFC 2965 (IETF 2000) and K. Moore et al., Use of HTTP State Management, RFC 2964 (IETF 2000). When a client issues an HTTP request to a server, the server may attempt to send state information (also referred to as “cookie” information or simply a cookie) to the client. If the client accepts the cookie, the client may then send the cookie with any subsequent requests to the server. In this manner, the server may differentiate among a potentially huge number of otherwise identical requests.

Generally speaking, the present invention contemplates using information available to the server to enable it to determine if a server page or other information is being accessed out-of-order, by an unauthorized user, or otherwise “out of context.” When a server according to the present invention detects such an occurrence, the server returns a version (the modified version) of the requested document that differs from the version returned to a client having access authority. The modified version of the document may convey information informing the client that the document being viewed has been accessed out of context. The server may use information contained in the referer field of an HTTP request header, state information conveyed using cookies, or a combination of both to determine whether a requested document has been accessed within context.

Portions of the present invention may be implemented as a set of computer executable instructions (software) for responding to a client request for a document or other information on a server such as server 111. The software may reside on a computer readable medium. When being executed by one or more processors of server 111, portions of the software may reside in a volatile storage medium such as the system memory of server 111 or a processor cache memory. During other times, the software may reside on a non-volatile storage medium such as a floppy diskette, hard disk, CD ROM, DVD, magnetic tape, flash memory or other electrically erasable programmable ROM device.

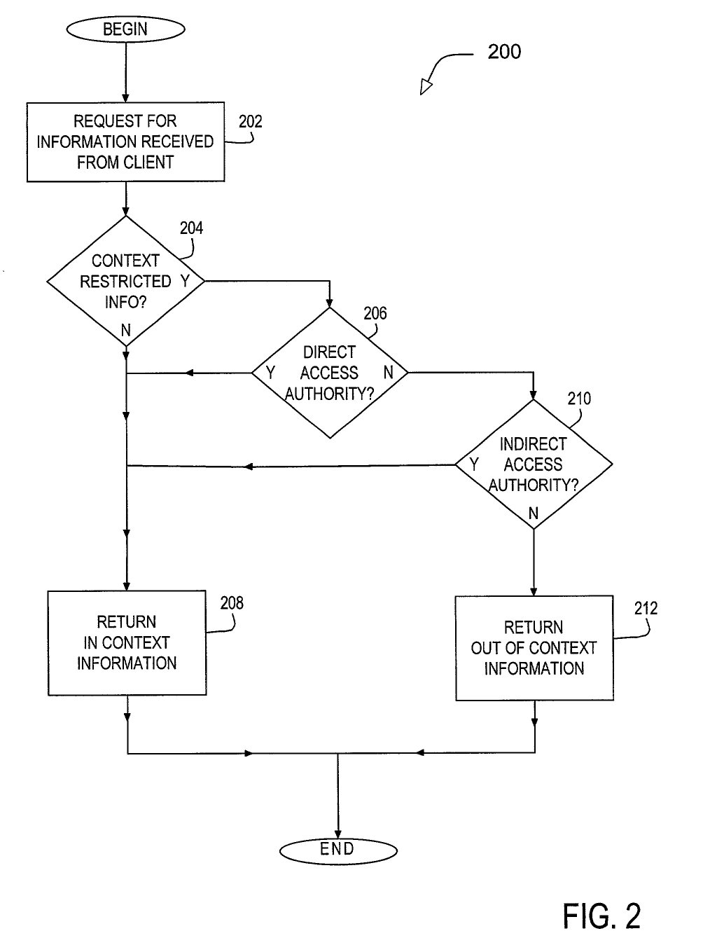

Referring now to FIG. 2, a flow diagram is presented to illustrate a method 200 of responding to client requests to ensure “in context” access according to one embodiment of the present invention. In the depicted embodiment of method 200, a server device such as server 111 receives (block 202) a request for information from a client application. The request includes a request-URI specifying a file or other document requested by the client. A common example of such a request is an HTTP compliant GET request in which a client specifies the URI of a web page that the user wishes to view. The GET request is typically generated with the assistance of an application program running on the client device that includes a graphical user interface (GUI). Internet browser applications, for example, include a GUI that enables the user to initiate an HTTP request simply by entering the desired URI in the appropriate location of the GUI.

Upon receiving a request, the server may initially make a determination (block 204), of whether the document specified by request-URI is context restricted (referred to herein as a “contextual” URI). For purposes of this disclosure, a context restricted document refers to a document to which the server grants access only after ensuring that the client is or has been made aware of one or more documents that provide the context for the requested document. The server may include web pages that are intended to be freely and publicly accessible by substantially any client. The home page of a web site, for example, represents a page that is typically intended to be accessible without regard to the context in which the page is accessed. In other words, the home page of a web site is intended to be freely accessible by a client that requests the URI of that home page regardless of which URI's the client has accessed previously. Moreover, a homepage is typically permitted to be freely “quoted” by a referring application. Thus, the author of a URI homepage typically permits the authors of other web pages to freely embed a link in their web documents that, when clicked upon, will direct a client to the homepage. Although the discussion above uses a homepage as an example of a document to which unrestricted access is desired, it will be appreciated that many other documents and/or web pages may be designed for unrestricted access without regard to context.

If the server determines in block 204 that the request-URI identifies a document to which unrestricted access applies, the server will respond by returning (block 208) the requested document to the client without modification or restriction. If, on the other hand, the server determines that the document specified by the request-URI is a document to which access should be restricted to maintain the document within some predetermined context, the server will then attempt to determine if the request has been made within that context. Web page authors may wish to maintain documents within a specified context for a wide variety of reasons. In a relatively simple example, a set of web pages may represent successive pages of a continuous document. The author may wish to insure that a client who jumps into the middle of the document, having never been to the origin of the document, is admonished to access the document's origin before proceeding.

If the server determines in block 204 that the client has requested a document that is intended to be viewed within some context defined by the server, the server will then determine whether the current request has been made within that context. In the depicted embodiment of method 200, context verification includes a two-tiered verification or authentication process. Initially, the server may determine (block 206) if the client has what is referred to in this disclosure as direct access authority. Direct access authority may be obtained when the client itself has previously accessed a document or sequence of documents on the server that provide the necessary context for viewing the currently requested document. If the client request does not indicate direct access authority, the server will then attempt to determine (block 210) if the client has indirect or “referred” access authority. Indirect authority occurs when a server document is quoted to a client by a third party server, the referring server, that is authorized by the origin server (the server containing the requested URI). If the server determines that a request for a contextual document has neither direct nor indirect authority, the server indicates (block 212) the lack of authority to the client. If the server determines that a request has either direct or indirect access authority, the server responds by providing (block 208) the requested document to the client without context warning and without modification of the requested document.

The preceding paragraphs describe generally the process by which a client request for a document is handled by a “context aware” server. The following paragraphs describe implementation details of the general method that are particularly suitable for use in Internet transactions involving HTTP compliant client requests and server responses. These implementation details represent possible implementations and it will be appreciated that other implementation specifics will fall within the scope of the context authorization method described.

In one implementation, the client request identified in block 202 of FIG. 2 is an HTTP client request. Such requests include a request-URI field that indicates the URI from which the client is attempting to retrieve a document or other information. Such client requests, as described previously, may include information such as referrer information and cookie information that are contained in a header field of the request. The cookie will generally contain, at a minimum, information such as a user ID that uniquely identifies the client to the server.

In one embodiment, cookie information is used to determine whether the client has direct access authority with respect to the requested document. When a request for a contextual document is received from the client, the server may look at any cookies supplied with the request to determine if the client has direct access authority for the requested document. If, as an example, an author creates a set of web pages comprising a main page and a set of subordinate pages and the author wishes to provide the subordinate pages only to those who have visited the main page, the server may be configured to generate a cookie when the client accesses the main page. This cookie would presumably be returned to the server by the client with any subsequent client requests to access the subordinate pages. In this case, the cookie indicates to the server that the client has previously accessed the main page and should, therefore, be able to freely view the subordinate pages.

Those skilled in HTTP and state mechanisms will be able to envision more complex context scenarios in which, for example, direct access to a page in a set of documents is predicated upon the existence of a cookie that is generated only when the client requests the preceding page. In this embodiment, the client is constrained initially to access each page in order to avoid receiving some form of context error. Furthermore, cookie parameters in addition to or in lieu of a user ID could be used to control access. The server could, for example, use the path parameter described in RFC 2965 in conjunction with the organization of the relevant documents in suitable directories to control the direct access authority of a client. See, e.g., Persistent Client State HTTP Cookies, Examples (Netscape Communications Corp. 1999) available at (www.netscape.com/newsref/std/cookie_spec.html). In this arrangement, the server could send a cookie when Page 1 of a document is accessed where the path parameter is equal to the path in which Page 2 of the document resides. Only those who have visited Page 1 have the cookie that gives direct access authority to Page 2.

Direct access control may be further enhanced by the use of a Max-age parameter in the cookie to control the amount of time for which the cookie is valid. The client discards cookies that are older than their Max-age parameter. If the server documents are modified relatively frequently, the server can assign relatively short lifetimes to the cookie. When the server documents are static or change relatively infrequently, the Max-age parameter can be increased.

If the requesting client does not have direct access authority, the server then determines whether the server document has been “quoted” to the client by a third party server that has indirect access authority. The determination of whether a request has valid indirect access authority may be accomplished via the request header field of an HTTP request. More specifically, the server may examine the Referer field of an HTTP request header to determine if the request has been referred to the client by an “authorized” server. As used in this disclosure, an authorized server refers to a third party server that has registered or otherwise established itself with the targeted server such that the targeted server can be assured that the third party server is referring pages to the requesting client in context.

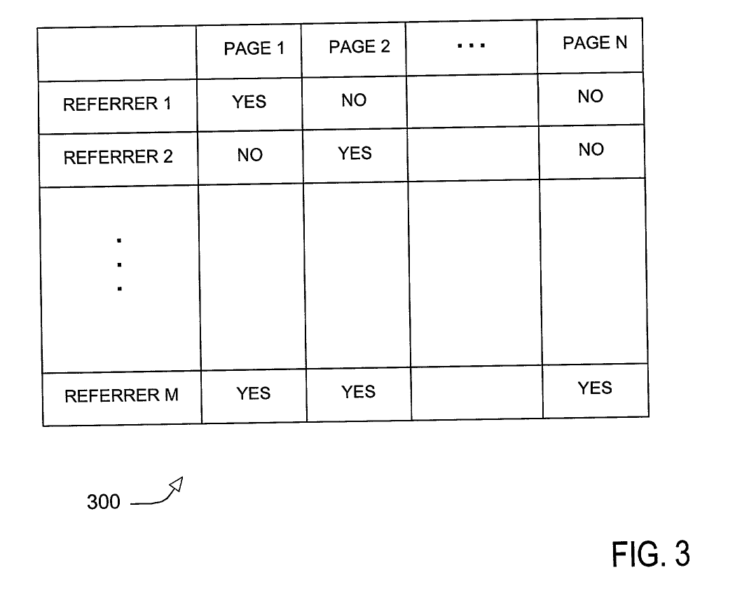

The targeted server may verify indirect access authority using stored information identifying the third party servers that have registered with the targeted server. Referring now to FIG. 3, an example of a table 300 suitable for storing and retrieving information indicating which third party servers are authorized to refer clients to particular pages. Table 300 as depicted in FIG. 3 includes a set of M rows and N columns. Each row represents the IP address, domain name, URI, or other identifying information of a third-party server that is registered with the targeted server. Each column represents the URI of a document or page on the targeted server. For each row and column entry, the targeted server maintains information indicating whether the third-party server corresponding to the row is authorized to quote the document corresponding to the column. Table 300 is preferably maintained in non-volatile storage such as disk storage of the targeted server or a storage device accessible from the targeted server. The targeted server may retrieve all or a portion of table 300 during operating to improve the response time.

Table 300 may also be used to provide an alternative form of direct access authority. As discussed previously, the targeted server may attempt to determine direct access authority using cookie information. In addition, however, the server may use stored information such as the information in table 300 to determine direct access authority. When a client request originates from a server that is represented by one of the row entries in table 300, the request is given direct access authority based upon the value in the table entry corresponding to the URI of the requested document. In other words, if a server has authority to quote a page to others, that server also has authority to access the page directly regardless of any cookie information that might be present in the request.

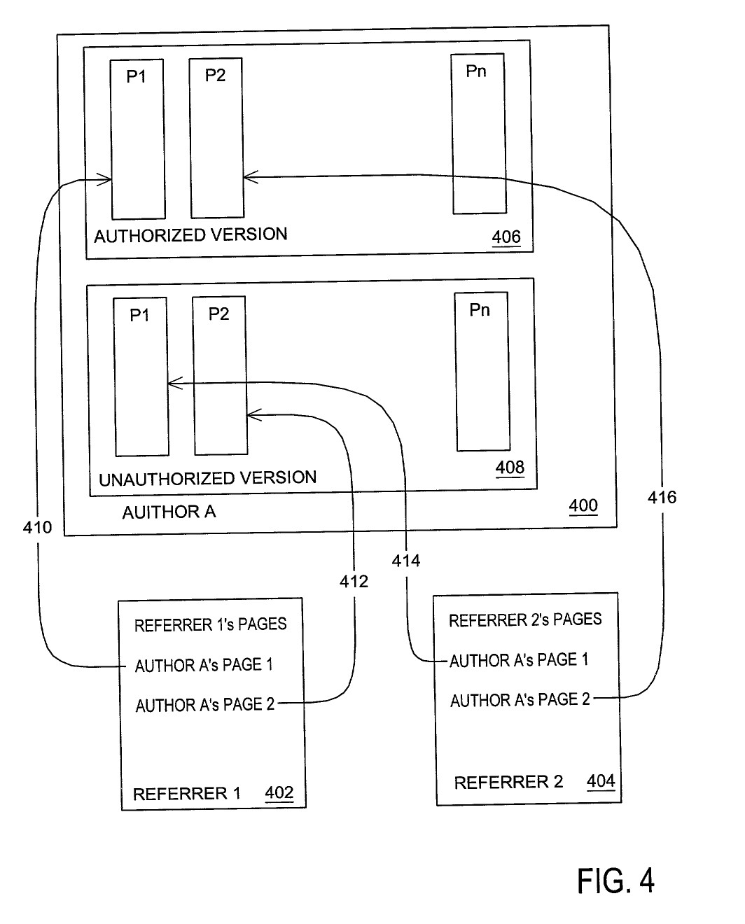

If the targeted server determines that a third party server is quoting a page that the third party server does not currently have permission to quote, the targeted server may produce a response that contains the requested information in a modified format designed to inform the client user that the page has been accessed out-of-context. Referring to FIG. 4, a conceptual illustration of the manner in which a server according to the present invention responds to client requests is presented. As depicted, the targeted server (indicated as Author A 400) includes two sets of documents. An authorized set of documents 406 includes the versions of each page that are returned to a client who has been quoted to the page from a third party server with indirect access authority. A second set of documents, the unauthorized set 408 includes the versions of each page that are returned to clients who have been referred to the documents by a client lacking indirect access authority.

FIG. 4 further illustrates a pair of third-party servers identified as Referrer 1 402 and Referrer 2 404. The arrows leading from the Referrers 402 and 404 to Author A 400 represent client requests to specific pages that have been referred by the respective referrers. Assuming that the permission table 300 of FIG. 3 represents the current state of permission/authorization for Referrers 402 and 404, the request represented by reference numeral 410 for Author A's Page 1 results in Author A returning the authorized version of Page 1 because Referrer 1 has indirect access authority to refer clients to page 1. Similarly, request 412 in which Referrer 1 quotes Author A's page 2 returns the unauthorized or modified version of Page 2 because Referrer 2 lacks authority to quote page 2. Request 414 illustrates Referrer 2 quoting Author A's page 1 resulting in Author A returning the unauthorized version of page 1 to the client while request 416 illustrates Referrer 2 quoting Author A's page 2 and the resulting return of the authorized version of Page 2.

In one embodiment, the authorized version of a page and the unauthorized version of that page may be generated from a common source to minimize the storage requirements. The targeted server may, for example, maintain a copy of the authorized pages in its file cache or disk storage. Whenever a client requests one of the pages and direct or indirect access is verified by the server, the server can retrieve the page from its file cache or disk and return the page to the client. If the server determines that the request lacks direct and indirect authority, the server may generate the unauthorized version of the page from the authorized version. In one implementation, the targeted server may retrieve the authorized version of a page and modify its appearance if the server determines that the request lacks authorization. This modification of a page's appearance could include simply inserting additional text that indicates to the client that the page has been accessed out of context. The inserted text would preferably have a large font or other highly visible characteristics to ensure that the client is notified. The targeted server could generate unauthorized versions of pages by first retrieving the authorized version and then running a script or other suitable sequence to modify the retrieved page to indicate improper context. This embodiment minimizes the amount of required memory without substantially adding to the response performance.

It should be noted that a client request for a contextual document requires either direct access authority or indirect access authority, but not necessarily both. Thus, if a client acquires direct access authority by, for example, visiting the homepage of a set of documents, that client does not further require indirect access authority (assuming the direct access authority is still valid) when later being quoted to the set of documents by a third party server. If a client with valid direct access authority to a document is subsequently quoted to the document by an unauthorized third party server, the third party server's lack of indirect access authority does not override the direct access authority or otherwise prevent the server from returning the in-context version of the requested document.

It will be apparent to those skilled in the art having the benefit of this disclosure that the present invention contemplates a method and system for responding to client requests in a manner that assures access is maintained in context. It is understood that the form of the invention shown and described in the detailed description and the drawings are to be taken merely as presently preferred examples. It is intended that the following claims be interpreted broadly to embrace all the variations of the preferred embodiments disclosed

What is claimed is:

1. A method of processing a client request for a document from a server in a data processing network, comprising:
determining whether the requested document is context restricted;
responsive to determining that the requested document is context restricted, determining whether the client has access authority to the requested document; and
responsive to determining that the client lacks access authority, responding to the client request by returning a version of the requested document that differs from a version returned to a client having access authority.

2. The method of claim 1, wherein determining whether the client has access authority includes determining whether the client has direct access authority.

3. The method of claim 2, wherein the client request comprises an HTTP formatted request and further wherein determining whether the client has direct access authority includes comparing state information contained in the request to a predetermined value.

4. The method of claim 3, wherein the state information required to acquire direct access authority is sent to the client when the client views a document or set of documents that provide the required context for the requested document.

5. The method of claim 1, wherein determining whether the client has access authority includes determining whether the client has indirect access authority.

6. The method of claim 5, wherein the client request comprises an HTTP formatted request and further wherein determining whether the client has indirect access authority includes determining whether the client has been referred to the requested document by a third party server.

7. The method of claim 6, wherein determining whether the client has been referred by a third party server comprises determining whether the value of a request header field in the client request matches at least one entry in a table of authorized referrers.

8. The method of claim 7, wherein the request header field comprises a referrer header field of an HTTP request and wherein the table of authorized referrers is stored permanent storage to which the server has access.

9. The method of claim 1, wherein returning a version of the requested document that differs includes retrieving the requested document and running an application to insert a visibly detectable notice indicating that the requested document is being viewed out of context.

10. A computer program product comprising a sequence of instructions for processing a client request for a document from a server in a data processing network, the sequence being encoded on a computer readable medium, comprising:
computer code means for determining whether the requested document is context restricted;
computer code means for determining whether the client has access authority to the requested document responsive to determining that the requested document is context restricted; and
computer code means for responding to the client request by returning a version of the requested document responsive to determining that the client lacks access authority, wherein the version differs from a version returned to a client having access authority.

11. The computer program product of claim 10, wherein the code means for determining whether the client has access authority includes code means for determining whether the client has direct access authority.

12. The computer program product of claim 11, wherein the client request comprises an HTTP formatted request and further wherein the code means for determining whether the client has direct access authority includes code means for comparing state information contained in the request to a predetermined value.

13. The computer program product of claim 12, wherein the state information required to acquire direct access authority is sent to the client when the client views a document or set of documents that provide the required context for the requested document.

14. The computer program product of claim 10, wherein the code means for determining whether the client has access authority includes code means for determining whether the client has indirect access authority.

15. The computer program product of claim 14, wherein the client request comprises an HTTP formatted request and further wherein the code means for determining whether the client has indirect access authority includes code means for determining whether the client has been referred to the requested document by a third party server.

16. The computer program product of claim 15, wherein the code means for determining whether the client has been referred by a third party server comprises code means for determining whether the value of a request header field in the client request matches at least one entry in a table of authorized referrers.

17. The computer program product of claim 16, wherein the request header field comprises a referrer header field of an HTTP request and wherein the table of authorized referrers is stored in permanent storage to which the server has access.

18. The computer program product of claim 10, wherein the code means for returning a version of the requested document that differs includes code means for retrieving the requested document and code means for running an application to insert a visibly detectable notice indicating that the requested document is being viewed out of context.

19. A server for use in a data processing network, the server including processor and memory containing a sequence of instructions for processing a client request for a document from a server in a data processing network, the sequence being encoded on a computer readable medium, the instructions comprising:
computer code means for determining whether the requested document is context restricted;
computer code means for determining whether the client has access authority to the requested document responsive to determining that the requested document is context restricted; and
computer code means for responding to the client request by returning a modified version of the requested document responsive to determining that the client lacks access authority, wherein the version differs from the requested document returned to a client having access authority.

20. The server of claim 19, wherein the code means for determining whether the client has access authority includes code means for determining whether the client has direct access authority.

21. The server of claim 20, wherein the client request comprises an HTTP formatted request and further wherein the code means for determining whether the client has direct access authority includes code means for comparing state information contained in the request to a predetermined value.

22. The server of claim 21, wherein the state information required to acquire direct access authority is sent to the client when the client views a document or set of documents that provide the required context for the requested document.

23. The server of claim 19, wherein the code means for determining whether the client has access authority includes code means for determining whether the client has indirect access authority.

24. The server of claim 23, wherein the client request comprises an HTTP formatted request and further wherein the code means for determining whether the client has indirect access authority includes code means for determining whether the client has been referred to the requested document by a third party server.

25. The server of claim 24, wherein the code means for determining whether the client has been referred by a third party server comprises code means for determining whether the value of a request header field in the client request matches at least one entry in a table of authorized referrers.

26. The server of claim 25, wherein the request header field comprises a referrer header field of an HTTP request and wherein the table of authorized referrers is stored in permanent storage to which the server has access.

27. The server of claim 19, wherein the code means for returning a modified version of the requested document includes code means for retrieving the requested document and code means for running an application to insert a visibly detectable notice indicating that the requested document is being viewed out of context.
